(19) United States
(12) Patent Application Publication
(10) Pub. No.: US 2008/0122291 A1
(43) Pub. Date: May 29, 2008

(54) Switching Power Supply Control Circuit, Switching Power Supply Device and Electronic Apparatus Employing the Same

(75) Inventors: Daisuke Uchimoto, Kyoto (JP); Hiroaki Ando, Kyoto (JP); Manabu Oyama, Kyoto (JP)

Correspondence Address: CANTOR COLBURN, LLP, 20 Church Street, 22nd Floor, Hartford, CT, 06103, US

(73) Assignee: ROHM CO., LTD, Ukyo-ku (JP)

(21) Appl. No.: 11/665,876

(22) PCT Filed: Sep. 8, 2005
(86) PCT No.: PCT/JP05/16491

§ 371 Date: Apr. 19, 2007

(30) Foreign Application Priority Data
Oct. 19, 2004 (JP) 2004-304808

(51) Int. Cl. H02J 1/00; G05F 1/10; H02M 3/155; G05F 1/44

(52) U.S. Cl. 307/31; 323/282; 323/271

(57) ABSTRACT

A control signal Vcont is input to a control terminal, thereby switching between a normal operation mode and a light-load mode. In the normal mode, a control unit turns on/off first switch through fourth switch, and outputs boosted voltages from a first output terminal and a second output terminal. When the light-load mode is selected, the control unit stops the switching of the second switch and fourth switch. In this case, current flows in first and second output capacitors via first and second diodes, respectively, and boosting operation is performed.

### BACKGROUND OF THE INVENTION

1. Field of the Invention

The present invention relates to a switching power supply apparatus.

2. Description of the Related Art

In a small-sized information terminal such as a cellular phone or a Personal Digital Assistance (PDA) in recent years, a device requiring a voltage higher than an output voltage of a battery such as a Light Emitting Diode (LED) used for backlight of a liquid crystal exists. For example, a Li ion battery is often used in the small-sized information terminals. The output voltage of the Li ion battery is usually about 3.5V and, at the time of full charge, is about 4.2V. The LED requires, as its drive voltage, a voltage higher than the battery voltage. In the case where a voltage higher than the battery voltage is necessary, the battery voltage is boosted by using a booster circuit such as a switching regulator, thereby obtaining a voltage necessary for driving a load circuit such as an LED.

Patent Document 1 describes a technique for providing a low-cost and space-saving switching power supply apparatus capable of generating a plurality of output voltages. In the technique, by sharing an inductor and a main switch by a plurality of output voltages, the number of parts of a switching regulator for outputting a plurality of DC voltages is reduced. [Patent Document 1] Japanese Patent Application Laid-Open No. 2003-289666

According to the technique described in the above document, a plurality of boosted DC voltages can be obtained with a simple circuit configuration. However, when attention is paid to power consumption, that is, efficiency of the power supply apparatus, there is room for improvement.

### SUMMARY OF THE INVENTION

The present invention has been achieved in view of such circumstances and a general purpose of the invention is to provide a booster circuit for outputting a plurality of output voltages at the same time like the technique described in the above document and, further, to provide a switching power supply apparatus with reduced power consumption and a control circuit of the same.

An embodiment of the present invention relates to a switching power supply control circuit. The switching power supply control circuit for boosting an input voltage and outputting a plurality of output voltages includes: an input terminal to which the input voltage is applied via an external inductor; a first output terminal for outputting a first boosted output voltage and in which a first external output capacitor is to be connected between the first terminal and a ground potential terminal; a second output terminal for outputting a second boosted output voltage and in which a second external output capacitor is to be connected between the second terminal and a ground potential terminal; a first switch provided between the input terminal and a ground potential terminal; a second switch provided between the input terminal and the first output terminal; third and fourth switches provided in series between the input terminal and the second output terminal; and a control unit for controlling on/off of the first to fourth switches.

The switching power supply control circuit forms, with the external inductor and the first and second output capacitors, a booster-type DC/DC converter for outputting two voltages, and outputs first and second output voltages from the first and second output terminals. According to this embodiment, by turning off the third switch at the time of outputting a voltage higher than a voltage from the second terminal from the first output terminal, current can be prevented from flowing in the second output capacitor via the second diode. Thus, the switching power supply apparatus can operate stably.

In normal operation, the control unit may alternately repeat a first period in which the first switch and second switch are turned on in a sequential order, and a second period in which the first switch and third switch are turned on in a sequential order. In light-load operation, the control unit may alternately repeat a third period in which the first switch is turned on, and a fourth period in which the first switch and third switch are turned on in a sequential order.

In the case of forming a switch by a Metal Oxide Semiconductor (MOS) transistor, to change the gate voltage, current for charging/discharging a gate capacitance is necessary. In the case of forming a switch by a bipolar transistor, base current has to be supplied. Therefore, in the light-load operation, by stopping on/off operation of the second and fourth switches and supplying current to the first and second output capacitors via the first and second diodes, the current for turning on/off the second and fourth switches becomes unnecessary, so that the power consumption of the switching power supply control circuit can be reduced.

The first switch may be an N-type MOS transistor, and the second, third, and fourth switches may be P-type MOS transistors. Switching signals output from the control unit may be input to the gate terminals of the first switch through fourth switches, a back gate terminal of the first switch may be connected to the ground potential terminal, back gate terminals of the second and third switches are connected to the first output terminal, and a back gate terminal of the fourth switch may be connected to the second output terminal.

By connecting the back gates of the MOS transistors forming the first switch to fourth switch in such a manner, the circuit can operate stably.

Also before start of the boosting operation such as start of the switching power supply apparatus, a voltage obtained by dropping an input voltage only by a forward voltage of the first diode appears in the first output terminal. By connecting the back gate of the MOS transistor forming the third switch to the first output terminal, the third switch can be stabilized at the time of start of the switching power supply apparatus and the like.

The switching power supply control circuit may be integrated on a single semiconductor substrate. “Integration” includes the case where all of the components of the circuit are formed on a semiconductor substrate, and the case where main components of the circuit are integrated. For adjustment of a circuit constant, a part of resistors, capacitors, and the like may be provided on the outside of the semiconductor substrate. By integrating the switching power supply control circuit as a single LSI, the circuit area can be reduced.

Another embodiment of the invention relates to a switching power supply apparatus. The switching power supply apparatus for boosting an input voltage and outputting a plurality of output voltages includes: an input terminal to which the input voltage is applied; a first output terminal for outputting a first output voltage obtained by boosting the input voltage; a second output terminal for outputting a second output voltage obtained by boosting the input voltage; a first output capacitor provided between the first output terminal and a ground potential terminal; a second output capacitor provided between the second output terminal and a ground potential terminal; an inductor connected to the input terminal; a first switch provided between the inductor and a ground potential terminal; a second switch provided between a connection point of the inductor and the first switch and the first output terminal; third and fourth switches provided in series between the connection point of the inductor and the first switch and the second output terminal; a control unit for controlling on/off of the first to fourth switches; a first diode provided in parallel with the second switch so that a cathode terminal is positioned on the second output terminal side; and a second diode provided in parallel with the fourth switch so that a cathode terminal is positioned on the second output terminal side.

According to the embodiment, by providing the first and second diodes in parallel with the second and fourth switches, also in the case where the switching operation of the second and fourth switches is stopped in light-load operation, a boosted output voltage can be obtained. Further, by turning off the third switch at the time of outputting a voltage higher than that of the second output terminal from the first output terminal, current can be prevented from flowing in the second output capacitor via the second diode. Consequently, the switching power supply apparatus can operate stably.

In normal operation, the control unit may alternately repeat a first period in which the first switch and second switch are turned on in a sequential order, and a second period in which the first switch and third switch are turned on in a sequential order and, in the period in which the third switch is on, the fourth switch is turned on. In light-load operation, the control unit may alternately repeat a third period in which the first switch is turned on, and a fourth period in which the first switch and third switch are turned on in a sequential order.

The control unit has a control terminal and, according to an instruction of a control signal input to the control terminal, may switch between the normal operation and the light-load operation.

A configuration may be employed in which the first switch is an N-type MOS transistor, the second, third, and fourth switches are P-type MOS transistors, switching signals output from the control unit are input to the gate terminals of the first switch through fourth switch, a back gate terminal of the first switch is connected to the ground potential terminal, back gate terminals of the second and third switches are connected to the first output terminal, and a back gate terminal of the fourth switch is connected to the second output terminal.

At least one of the first and second diodes may be formed by corresponding one of parasitic diodes of MOS transistors as second and fourth switches. When the parasitic diode of the MOS transistor is large, the parasitic diode may be used as the first or second diode.

Further another embodiment of the present invention also relates to a switching power supply apparatus. The device is a switching power supply apparatus for boosting an input voltage and outputting a plurality of output voltages, and includes: an input terminal to which the input voltage is applied; a plurality of output terminals for outputting a plurality of output voltages obtained by boosting the input voltage; an inductor and a main switch connected in series between the input terminal and a ground potential terminal; a plurality of synchronous rectification switches provided between a connection point of the inductor and the main switch and the plurality of output terminals; a plurality of diodes provided in parallel with the plurality of synchronous rectification switches; a plurality of output capacitors provided between the plurality of output terminals and a ground potential terminal; and a control unit for controlling on/off of the main switch and the plurality of synchronous rectification switches. The control unit alternately turns on/off the main switch and the plurality of switches in normal operation and turns on/off only the main switch in light-load operation.

According to this embodiment, in the light-load operation, only the main switch is turned on/of and the on/off operation of the plurality of synchronization rectification switch is stopped. Consequently, the current for turning on/off the plurality of synchronization rectification switches becomes unnecessary, so that power consumption can be reduced.

Further another embodiment of the invention relates to an electronic equipment. The electronic equipment includes: a battery; the above-described switching power supply apparatus for boosting voltage of the battery; and a plurality of loads driven by the first and second output voltages output from the switching power supply apparatus. In this embodiment, the power consumption of the switching power supply apparatus in the light-load operation is reduced. Thus, the life of the battery can be increased.

Embodiments obtained by arbitrary combinations of components and replacement of the components and expressions of the present invention among the methods, apparatuses, systems, and the like are also effective as embodiments of the invention.

It is to be noted that any arbitrary combination or rearrangement of the above-described structural components and so forth is effective as and encompassed by the present embodiments.

Moreover, this summary of the invention does not necessarily describe all necessary features so that the invention may also be a sub-combination of these described features.

### BRIEF DESCRIPTION OF THE DRAWINGS

Embodiments will now be described, by way of example only, with reference to the accompanying drawings which are meant to be exemplary, not limiting, and wherein like elements are numbered alike in several Figures, in which:

FIG. 1 is a diagram showing the configuration of a switching power supply apparatus according to an embodiment;

FIG. 2 is a block diagram showing the configuration of an electronic equipment on which the switching power supply apparatus of FIG. 1 is mounted;

FIG. 3 is a circuit diagram specifically showing the switching power supply apparatus of FIG. 1; and

FIGS. 4A and 4B are time charts showing an on/off state of each of switches in the switching power supply apparatus.

### DETAILED DESCRIPTION OF THE INVENTION

The invention will now be described based on preferred embodiments which do not intend to limit the scope of the present invention but exemplify the invention. All of the features and the combinations thereof described in the embodiment are not necessarily essential to the invention.

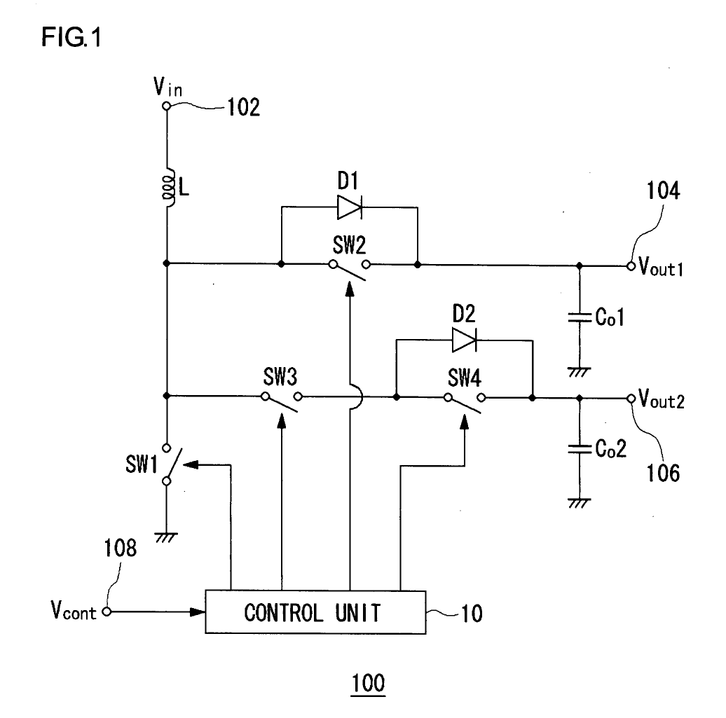

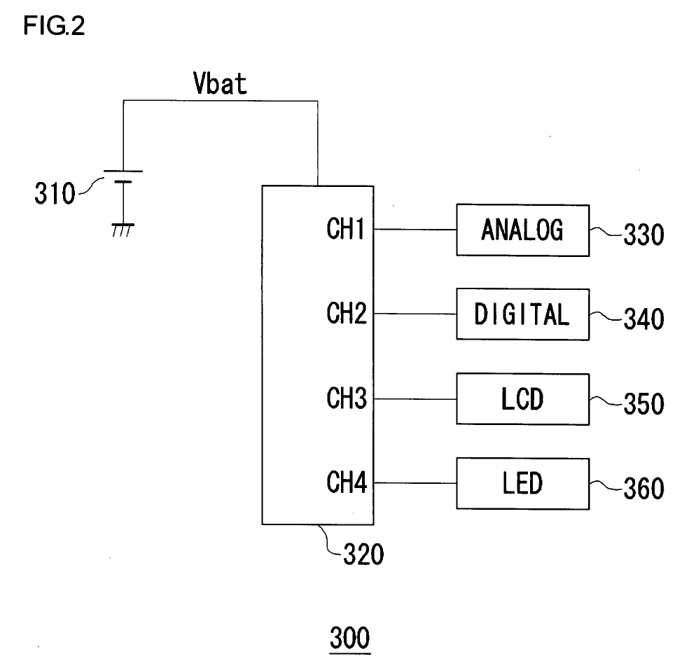

FIG. 1 shows the configuration of a switching power supply apparatus 100 according to an embodiment of the present invention. FIG. 2 is a block diagram showing the configuration of an electronic equipment 300 on which the switching power supply apparatus 100 of FIG. 1 is mounted.

The electronic equipment 300 of FIG. 2 is, for example, a battery-driven cellular phone terminal, PDA, or the like and includes a battery 310, a power supply apparatus 320, an analog circuit 330, a digital circuit 340, a liquid crystal panel (hereinbelow, called LCD panel) 350, and an LED 360.

The battery 310 is, for example, a lithium ion battery and outputs about 3V to 4V as a battery voltage Vbat. The analog circuit 330 includes a circuit block including a power amplifier, an antenna switch, a Low Noise Amplifier (LNA), a mixer, and a radio frequency circuit such as a Phase Locked Loop (PLL), and stably operating on a power supply voltage Vcc of about 3.4V. The digital circuit 340 also includes a circuit block including various digital signal processors (DSPs) and stably operating on a power supply voltage Vdd of about 3.4V.

The LCD panel 350 is a display device for displaying character information and image information to the user. For driving the LCD panel 350, a voltage higher than the battery voltage Vbat is required. The LED 360 includes Light Emitting Diodes (LEDs) of three colors of R, G, and B and is used as a backlight of the LCD panel 350 or illumination. For driving the LED 360, like the LCD panel 350, a drive voltage of 4V or higher is required.

The power supply apparatus 320 is a multi-channel switching power supply including a switching regulator for stepping down or stepping up the battery voltage Vbat on the channel unit basis, and supplying proper power supply voltages to the analog circuit 330, the digital circuit 340, the LCD panel 350, and the LED 360.

The switching power supply apparatus 100 according to the embodiment can be used for supplying power supply voltages to a plurality of loads operating on a voltage higher than the battery voltage Vbat such as the LCD panel 350 and the LED 360. In the following, the configuration of the switching power supply apparatus 100 according to the embodiment will be described in detail.

Referring again to FIG. 1, the switching power supply apparatus 100 has, as input/output terminals, an input terminal 102, a first output terminal 104, and a second output terminal 106. The switching power supply apparatus 100 boosts an input voltage Vin applied to the input terminal 102 and outputs a first output voltage Vout1 from the first output terminal 104 and a second output voltage Vout2 from the second output terminal 106.

The switching power supply apparatus 100 includes an inductor L, a first output capacitor Co1, a second output capacitor Co2, first switch SW1 through fourth switch SW4, a first diode D1, a second diode D2, and a control unit 10.

A first booster circuit for boosting the input voltage Vin is formed by the second switch SW2, the first diode D1, and the first output capacitor Co1 in addition to the inductor L and the first switch SW1.

The inductor L is connected to the input terminal 102. The first switch SW1 is connected between the inductor L and a ground terminal of a fixed potential and functions as a main switch of a switching-regulator-type booster circuit.

The second switch SW2 is connected between a connection point of the inductor L and the first switch SW1 and the first output terminal 104. The first diode D1 is connected in parallel with the second switch SW2. The first diode D1 is connected in such a manner that its cathode terminal is connected to the first output terminal 104 side and its anode terminal is connected to the inductor L side so that current flows from the inductor L to the first output terminal 104.

The on/off state of the first switch SW1 and second switch SW2 is controlled by the control unit 10. When the first switch SW1 is on and the second switch SW2 is off, inductor current flows from the input terminal 102 toward the ground terminal via the inductor L and the first switch SW1, and energy proportional to the square of the current is stored in the inductor L.

When the first switch SW1 is turned off and the second switch SW2 is turned on, the inductor current flowing to the ground terminal via the first switch SW1 flows to the second switch SW2 side. At this time, the energy accumulated in the inductor L is transferred to the first output capacitor Co1. Since a back electromotive force is generated in the direction of checking the current in the inductor L, the first output capacitor Co1 is charged by a voltage obtained by boosting the input voltage Vin. The boosted voltage is smoothed by the first output capacitor Co1 and the resultant voltage is output as the first output voltage Vout1.

The ratio between the first output voltage Vout1 and the input voltage Vin, that is, the voltage step-up ratio is determined according to the ratio of the on time of the first switch SW1 to the on time of the second switch SW2. The control unit 10 controls the on periods of the first switch SW1 and the second switch SW2 so as to obtain a desired voltage step-up ratio by a pulse width modulation (PWM) method while detecting the first output voltage Vout1.

Similarly, the second booster circuit is constructed by the third switch SW3, the fourth switch SW4, the second diode D2, and the second output capacitor Co2 in addition to the inductor L and the first switch SW1.

When the second booster circuit is compared with the first booster circuit, the configuration thereof is similar to that of the first booster circuit except for the point that the third switch SW3 is added. In the second booster circuit, the first switch SW1 is turned on to pass current to the inductor L and accumulate energy. By turning on the third switch SW3 and fourth switch SW4, the energy is transferred to the second output capacitor Co2 to boost the voltage. The voltage of the second output capacitor Co2 is smoothed, and the resultant voltage is output as the second output voltage Vout2 from the second output terminal 106.

In the embodiment, it is assumed that the voltage step-up ratio of the first booster circuit is set to be higher than that of the second booster circuit, and the relation of Vout1>Vout2 is satisfied between the first output voltage Vout1 and the second output voltage Vout2.

In the switching power supply apparatus 100, the operation mode is switched between the normal operation and the light-load operation. In the following, in the specification, the operation mode in the normal operation will be called a normal operation mode and the operation mode in the light-load operation will be called a light-load mode. The switching power supply apparatus 100 has a control terminal 108 to which a control signal Vcont for instructing the normal operation or the light-load operation is input. The control signal Vcont is input to the control unit 10 to switch the switching sequence of the first switch SW1 through fourth switch SW4 between the normal operation mode and the light-load mode. In the embodiment, it is assumed that the switching power supply apparatus 100 operates in the normal mode when the control signal Vcont is at the high level, and operates in the light-load mode when the control signal Vcont is at the low level.

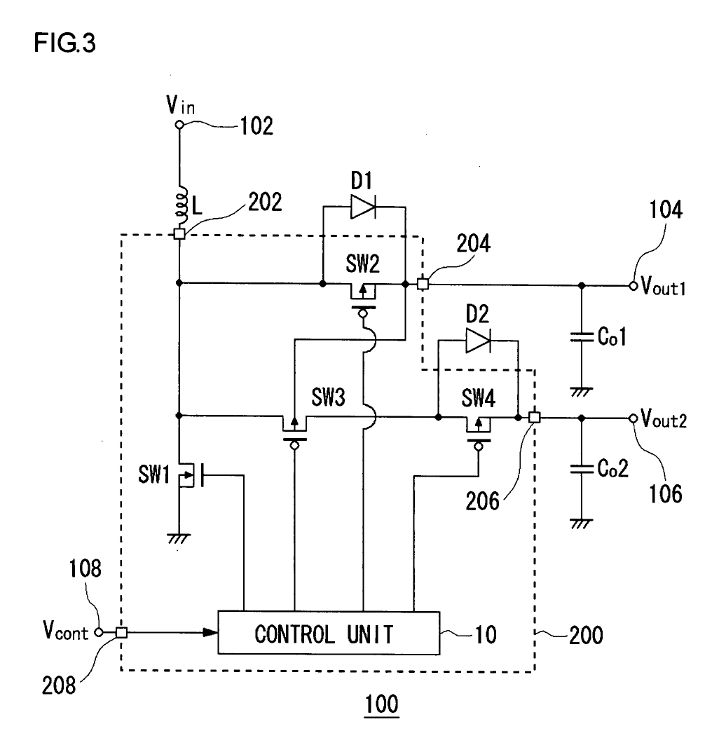

FIG. 3 is a circuit diagram showing the switching power supply apparatus according to the embodiment more specifically. In the diagram, an area surrounded by a broken line indicates a switching power supply control circuit 200 which is integrated. By externally attaching the inductor L, first output capacitor Co1, second output capacitor Co2, first diode D1, and second diode D2 to the switching power supply control circuit 200, the switching power supply apparatus 100 is constructed.

In the switching power supply control circuit 200, the first switch SW1 through the fourth switch SW4 are constructed by Metal Oxide Semiconductor Field Effect Transistors (MOSFETs).

To an input terminal 202, the input voltage Vin is applied via the external inductor L. A first output terminal 204 is a terminal for outputting the boosted first output voltage Vout1, and the external first output capacitor Co1 is connected between the first terminal and the ground potential terminal. A second output terminal 206 is a terminal for outputting the boosted second output voltage Vout2, and the external second output capacitor Co2 is connected between the second terminal and the ground potential terminal.

The first switch SW1 is an N-type MOS transistor and is provided between the input terminal 202 and the ground potential terminal. The back gate terminal of the first switch SW1 is grounded. The second switch SW2 is a P-type MOS transistor and is provided between the input terminal 202 and the first output terminal 204. The back gate terminal of the second switch SW2 is connected to the first output terminal 204. The third switch SW3 and fourth switch SW4 are provided in series between the input terminal 202 and the second output terminal 206 (106). The third switch SW3 is a P-type MOS transistor and its back gate terminal is connected to the first output terminal 204 (104). The fourth switch SW4 is also a P-type MOS transistor and its back gate terminal is connected to the second output terminal 206 (106).

The gate terminals of the first switch SW1 through fourth switch SW4 are connected to the control unit 10, a gate-source voltage is controlled by switching signals, and an on/off state is switched.

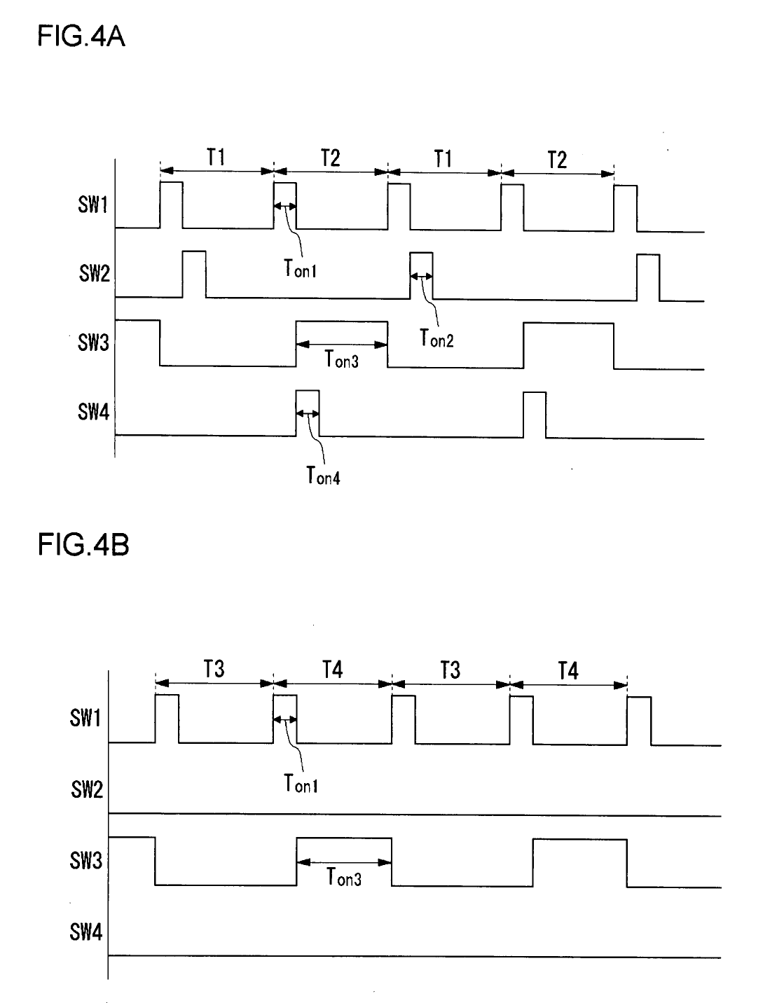

The operation of the switching power supply apparatus 100 constructed as described above will be described on the basis of FIGS. 4A and 4B. FIGS. 4A and 4B are time charts showing on/off states of the switches in the switching power supply apparatus 100. FIGS. 4A and 4B show time charts in the normal operation mode and the light-load mode, respectively. In the time charts of FIGS. 4A and 4B, the high level corresponds to the on state of a switch, and the low level corresponds to the off state of a switch.

First, the operation in the normal operation mode of the switching power supply apparatus 100 will be described. When a high-level signal is input as the control signal Vcont to the control terminal 108, the switching power supply apparatus 100 operates in the normal mode.

In the normal mode, as shown in FIG. 4A, by alternately repeating a first period T1 and a second period T2, the input voltage Vin is boosted, the first output voltage Vout1 is output from the first output terminal 104, and the second output voltage Vout2 is output from the second output terminal 106.

In the first period T1, the first switch SW1 and second switch SW2 are turned on in a sequential order. By turning on the first switch SW1, current flows to the inductor L from the input terminal 102 to the ground terminal. In the inductor L, energy proportional to the square of current is accumulated.

Next, by turning off the first switch SW1 and turning on the second switch SW2, the current flowing in the inductor L flows to the first output capacitor Co1 connected to the first output terminal 104, and the accumulated energy is transferred to the first output capacitor Co1. As a result, a back electromotive force is generated in the inductor L, and a voltage obtained by boosting the input voltage Vin is output to the first output terminal 104.

In the second period T2, the first switch SW1 and third switch SW3 are turned on in a sequential order. When the first switch SW1 is turned on, in the inductor L, current flows again from the input terminal 102 to the ground terminal and energy is accumulated.

After that, the first switch is turned off, and the third switch SW3 and fourth switch SW4 are turned on. The current flowing in the inductor L flows to the second output capacitor Co2 connected to the second output terminal 106, and the accumulated energy is transferred. As a result, a back electromotive force is generated in the inductor L, and a voltage obtained by boosting the input voltage Vin is output to the second output terminal 106.

An on period Ton3 of the third switch SW3 is fixed to be longer than the maximum value of an on period Ton4 of the fourth switch SW4, and the step-up ratio is adjusted according to the ratio between the on period Toni of the first switch SW1 and the on period Ton4 of the fourth switch SW4.

By alternately repeating the first period T1 of transferring the energy accumulated in the inductor L to the first output capacitor Co1 and the second period T2 of transferring the energy accumulated in the inductor L to the second output capacitor Co2, the first output voltage Vout1 and the second output voltage Vout2 are output.

Next, the operation in the light-load mode of the switching power supply apparatus 100 will be described. When the low-level signal is input as the control signal Vcont to the control terminal 108, the switching power supply apparatus 100 is switched to the light-load mode.

In the light-load mode, as shown in FIG. 4B, by alternately repeating a third period T3 and a fourth period T4, the input voltage Vin is boosted, the first output voltage Vout1 is output from the first output terminal 104, and the second output voltage Vout2 is output from the second output terminal 106.

In the third period T3, only the first switch SW1 is turned on. By the turn-on of the first switch SW1, in the inductor L, current flows from the input terminal 102 to the ground terminal. In the inductor L, energy proportional to the square of current is accumulated.

Next, the first switch SW1 is turned off. In the light-load mode, the second switch SW2 is not turned on. As a result, the current flowing in the inductor L flows to the first output capacitor Co1 connected to the first output terminal 104 via the first diode D1, and the energy accumulated in the inductor L is transferred to the first output capacitor Co1. Since a back electromotive force is generated in the inductor L, a voltage obtained by boosting the input voltage Vin is output to the first output terminal 104.

In the fourth period T4, the first switch SW1 and third switch SW3 are turned on in a sequential order. When the first switch SW1 is turned on, in the inductor L, current flows again from the input terminal 102 to the ground terminal and energy is accumulated.

Next, only the third switch SW3 is turned on, and the fourth switch SW4 is left off. As a result, the current flowing in the inductor L flows to the second output capacitor Co2 via the third switch and the second diode D2, and the accumulated energy is transferred to the second output capacitor Co2.

To change the gate voltage of a MOS transistor as a component of a switch, the gate capacitance has to be charged/discharged. Consequently, at the time of turning on/off the switch, current consumption occurs in the control unit 10. Therefore, by stopping the on/off switching of the second switch SW2 and fourth switch SW4 when the load is light, the current consumption decreases and the efficiency in the light-load mode is improved.

By providing the third switch SW3 in series with the fourth switch SW4, the following effects are obtained. In the embodiment, the first switch SW1 through fourth switch SW4 are controlled so that the relation of Vout1>Vout2 where Vout1 denotes the first output voltage and Vout2 denotes the second output voltage is satisfied. If the third switch SW3 is not provided, there is the possibility that a voltage larger than the forward voltage Vf is applied to the second diode D2 and the second diode D2 is turned on. When the second diode D2 is turned on, a problem occurs such that although the energy accumulated in the inductor L is to be transferred to the first output capacitor Co1 in the first period T1 in the normal operation mode or in the third period T3 in the light-load mode, current flows in the second output capacitor Co2 via the second diode D2.

Therefore, by providing the third switch SW3 and turning off the second diode D2 in the first and third periods T1 and T3, normal boosting operation can be performed also in the case where Vout1>Vout2.

By connecting the back gate of the third switch SW3 to the first output terminal 104, the following effects are obtained. To normally switch the on/off state of the third switch SW3, the back gate terminal has to be fixed at a high potential. However, on start of the switching power supply apparatus 100, the voltage at the connection point of the third switch SW3 and fourth switch SW4 is unstable. Therefore, if the back gate terminal is connected to the connection point, it is feared that the second output voltage Vout2 does not rise normally. On the other hand, a voltage obtained by dropping the input voltage Vin only by the amount of the forward voltage Vf of the first diode D1 also just after start is output and is stabilized. Therefore, by connecting the back gate terminal of the third switch SW3 to the first output terminal 104, the stability of the switching power supply apparatus 100 can be increased.

It is understood by a person skilled in the art that the embodiment is illustrative, combinations of components and processes can be variously modified, and such modifications are within the scope of the present invention.

In the case where a parasitic diode of a MOS transistor as a component of the second switch SW2 is formed with a sufficient size, the first diode D1 may be replaced by the parasitic diode. Similarly, the second diode D2 may be also replaced by the parasitic diode of the fourth switch SW4.

The element formed in the MOSFET in the embodiment can be replaced by other transistors such as a bipolar transistor. It is sufficient to determine the selections in accordance with the semiconductor manufacturing process, the cost, and the use required for the circuit.

In the embodiment, the case where the switching power supply control circuit 200 is integrated has been described. Alternatively, all of elements forming the switching power supply apparatus 100 may be integrated or formed in different integrated circuits. Further, apart of the elements of the switching power supply apparatus 100 may be formed by a discrete part. A part to be integrated may be determined in accordance with the cost, occupation area, use, and the like.

While the preferred embodiments of the present invention have been described using specific terms, such description is for illustrative purposes only, and it is to be understood that changes and variations may be made without departing from the spirit or scope of the appended claims.

1. A switching power supply control circuit for boosting an input voltage and outputting a plurality of output voltages, comprising:
an input terminal to which the input voltage is applied via an external inductor;
a first output terminal for outputting a first boosted output voltage and in which a first external output capacitor is to be connected between the first terminal and a ground potential terminal;
a second output terminal for outputting a second boosted output voltage and in which a second external output capacitor is to be connected between the second terminal and a ground potential terminal;
a first switch provided between the input terminal and a ground potential terminal;
a second switch provided between the input terminal and the first output terminal;
third and fourth switches provided in series between the input terminal and the second output terminal; and
a control unit for controlling on/off of the first to fourth switches.

2. The switching power supply control circuit according to claim 1, wherein
in normal operation, the control unit alternately repeats;
a first period in which the first switch and second switch are turned on in a sequential order; and
a second period in which the first switch and third switch are turned on in a sequential order and, in the period in which the third switch is on, the fourth switch is turned on and;
in light-load operation, the control unit alternately repeats;
a third period in which the first switch is turned on; and
a fourth period in which the first switch and third switch are turned on in a sequential order.

3. The switching power supply control circuit according to claim 1, wherein
the first switch is an N-type MOS transistor, the second, third, and fourth switches are P-type MOS transistors;
switching signals output from the control unit are input to the gate terminals of the first switch through fourth switch;
a back gate terminal of the first switch is connected to the ground potential terminal;
back gate terminals of the second and third switches are connected to the first output terminal; and
a back gate terminal of the fourth switch is connected to the second output terminal.

4. The switching power supply control circuit according to claim 1, wherein
the switching power supply control circuit is integrated on a single semiconductor substrate.

5. A switching power supply apparatus for boosting an input voltage and outputting a plurality of output voltages, comprising:
an input terminal to which the input voltage is applied;
a first output terminal for outputting a first output voltage obtained by boosting the input voltage;
a second output terminal for outputting a second output voltage obtained by boosting the input voltage;
a first output capacitor provided between the first output terminal and a ground potential terminal;
a second output capacitor provided between the second output terminal and a ground potential terminal;
an inductor connected to the input terminal;
a first switch provided between the inductor and a ground potential terminal;
a second switch provided between a connection point of the inductor and the first switch and the first output terminal;
third and fourth switches provided in series between the connection point of the inductor and the first switch and the second output terminal;
a control unit for controlling on/off of the first to fourth switches;
a first diode provided in parallel with the second switch so that a cathode terminal is positioned on the second output terminal side; and
a second diode provided in parallel with the fourth switch so that a cathode terminal is positioned on the second output terminal side.

6. The switching power supply apparatus according to claim 5, wherein
in normal operation, the control unit alternately repeats;
a first period in which the first switch and second switch are turned on in a sequential order; and
a second period in which the first switch and third switch are turned on in a sequential order and, in the period in which the third switch is on, the fourth switch is turned on and;
in light-load operation, the control unit alternately repeats;
a third period in which the first switch is turned on; and
a fourth period in which the first switch and third switch are turned on in a sequential order.

7. The switching power supply apparatus according to claim 6, wherein
the control unit has a control terminal and switches between the normal operation and the light-load operation according to an instruction of a control signal input to the control terminal.

8. The switching power supply apparatus according to claim 5, wherein
the first switch is an N-type MOS transistor, the second, third, and fourth switches are P-type MOS transistors;
switching signals output from the control unit are input to the gate terminals of the first switch through fourth switch;
a back gate terminal of the first switch is connected to the ground potential terminal;
back gate terminals of the second and third switches are connected to the first output terminal; and
a back gate terminal of the fourth switch is connected to the second output terminal.

9. The switching power supply apparatus according to claim 8, wherein
at least one of the first and second diodes is formed by corresponding one of parasitic diodes of MOS transistors as second and fourth switches.

10. A switching power supply apparatus for boosting an input voltage and outputting a plurality of output voltages, comprising:
an input terminal to which the input voltage is applied;
a plurality of output terminals for outputting a plurality of output voltages obtained by boosting the input voltage;
an inductor and a main switch connected in series between the input terminal and a ground potential terminal;
a plurality of synchronous rectification switches provided between a connection point of the inductor and the main switch and the plurality of output terminals;
a plurality of diodes provided in parallel with the plurality of synchronous rectification switches;
a plurality of output capacitors provided between the plurality of output terminals and a ground potential terminal; and
a control unit for controlling on/off of the main switch and the plurality of synchronous rectification switches;
wherein the control unit alternately turns on/off the main switch and the plurality of switches in normal operation and turns on/off only the main switch in light-load operation.

11. An electronic equipment comprising:
a battery;
the switching power supply apparatus according to claim 5, for boosting voltage of the battery; and
a plurality of loads driven by the first and second output voltages output from the switching power supply apparatus.

12. An electronic equipment comprising:
a battery;
the switching power supply apparatus according to claim 8, for boosting voltage of the battery; and
a plurality of loads driven by the first and second output voltages output from the switching power supply apparatus.
